(19) United States
(12) Patent Application Publication
(10) Pub. No.: US 2012/0041599 A1
(43) Pub. Date: Feb. 16, 2012

(54) TELEOPERATOR SYSTEM WITH MASTER CONTROLLER DEVICE AND MULTIPLE REMOTE SLAVE DEVICES

(76) Inventors: William T. Townsend, Weston, MA (US); David Wilkinson, Dedham, MA (US); Brian Zenowich, West Newton, MA (US)

(21) Appl. No.: 13/207,928

(22) Filed: Aug. 11, 2011

Related U.S. Application Data
(60) Provisional application No. 61/401,368, filed on Aug. 11, 2010.
(60) Provisional application No. 61/487,968, filed on May 19, 2011.

(51) Int. Cl. B25J 9/18; B25J 9/06

(52) U.S. Cl. 700/275; 901/9

(57) ABSTRACT

This invention enables the affordability of an elaborate, high-performance teleoperator master controller while encouraging continual operator training by supporting a teleoperator system in which one centralized master controller controls multiple field slaves sequentially.

### REFERENCE TO PENDING PRIOR PATENT APPLICATIONS

This patent application claims benefit of:

(i) pending prior U.S. Provisional Patent Application Ser. No. 61/401,368, filed Aug. 11, 2010 by William T. Townsend et al. for AVATAR TELEOPERATOR WITH MASTER DEVICE AND MULTIPLE REMOTE SLAVED ROBOTIC DEVICES (Attorney's Docket No. BARRETT-47798-86521P2 PROV); and

(ii) pending prior U.S. Provisional Patent Application Ser. No. 61/487,968, filed May 19, 2011 by William T. Townsend for AVATAR TELEOPERATOR WITH MASTER DEVICE AND MULTIPLE REMOTE SLAVED ROBOTIC DEVICES (Attorney's Docket No. BARRETT-47798-86521A PROV).

The two (2) above-identified patent applications are hereby incorporated herein by reference.

### FIELD OF THE INVENTION

This invention relates to robotic systems in general, and more particularly to teleoperator robotic systems.

### BACKGROUND OF THE INVENTION

In the last few years, there have been attempts at building robotic systems consisting of a multiple-link robotic arm mounted on an unmanned ground vehicle (UGV) to help disable and dispose of improvised explosive devices (IEDs) and mines, from current and past battlefields as well as among populations, as in the present day conflicts in Iraq and Afghanistan. In these systems, the robotic arm is remotely controlled by a master controller, in a master/slave telerobotic configuration. The master controllers are deployed in the field along with their slave robotic devices, where each master controller is dedicated to controlling one slave robotic device.

With current systems, the telerobotic arms have generally not been designed to sense and feed back forces and/or torques to the remote operator, particularly not contacts against the link structures (i.e., the body) of the arms, so the operators remotely “driving” these robotic arms cannot “feel” their way through a task. In these cases, the only feedback provided to the operator is visual, either via a video camera attached to the slave robotic device or via direct line-of-sight, or both. Of course, many tasks can be accomplished better and faster if an experienced operator has access to force and torque feedback, so that the operator can “feel”, as well as see, his/her way through the task. However, leveraging the ability to see and feel, especially along the body of the telerobotic arm, brings the need for (1) a high-performance, elaborate master controller capable of acquiring, processing and conveying both sight and feel data, and (2) up-to-date training from more-experienced operators who maintain the highest level of skill.

A military and homeland security example of the foregoing considerations is the challenge of frisking men and women while respecting local customs, where issues like gender matter. Robots are gender-neutral. Near the battlefield, the frisking situation is more dire because the target suspect may be a suicide bomber. Regardless of the circumstances, the ability of the operator to “feel” through the telerobotic system is essential in order for the operator to do the frisking task at all, and it requires highly skilled operators to properly operate the master controller.

So-called “through-the-window” (i.e., through an open window) bomb sniffing and video inspection of vehicle interior spaces need robotic solutions for similar reasons.

Enabling these tasks requires higher dexterity (i.e., more degrees of freedom) from the telerobotic system, and controlling more degrees of freedom also requires more highly skilled operators.

Thus, one can see the importance of an operator having as much skill as possible. However, attaining and maintaining a high level of skill is challenging, since any single IED team typically spends most of its time trying to find the next IED, and it typically spends only a small fraction of its time actually driving the robot up to the IED and then disabling and disposing of the IED. Stated another way, telerobotic systems require high operator skill levels in order to achieve maximum system effectiveness. However, it is difficult to attain and maintain high skill levels for the telerobotic operators, since the majority of their time is spent in locating the IED and not in actually approaching, disabling and disposing of the IED.

Raymond Goertz designed the first master-and-slave telerobot (aka teleoperator) in 1951 at Argonne National Laboratory for the handling of nuclear materials. A human operator handling a telerobotic system works something like a puppeteer handling a puppet, where the puppet is the slave robotic device, the puppet handle is the master controller, and the connecting strings are the electrical wires and/or wireless transceivers (and electronic subsystems) that connect the slave robotic device to the master controller. In a puppet system, if one of the puppet's arms gets snagged on an object, the puppeteer can feel that snag due to the mechanical connection between the puppet and the puppeteer. In most telerobots today, however, the operator cannot feel that a snag, or any other type of physical interaction, has occurred at the slave device, e.g., at the robotic arm. Such bilateral sensing capability is technically feasible, but in practice it is difficult to implement successfully without special mechanisms (see U.S. Pat. Nos. 4,903,536 and 5,046,375) with good force feedback and dynamic responses. In the unilateral control scheme of most conventional teleoperator robotic systems, the slave device simply attempts to follow the master controller—and it may or may not succeed. Furthermore, today's telerobots generally only control the trajectory of the tool attached to the distal end of the slave robotic arm, which typically consists of multiple links connected by powered joints. However, it is technically feasible to control the full body (i.e., inner and outer links, plus elbow) of the robotic arm independently from the endtip motion (see U.S. Pat. No. 5,207,114).

Although camera(s) (mounted on or near the slave, or both) may allow the operator to see what is happening in the task space, doing so can be disorienting for an operator without continual practice. Therefore, operators generally prefer to remain within line-of-sight of the remote slave device. However, in hostile areas such as war zones, insurgent snipers (who know that the operator will tend to be close by) actively search for the location of, and target, the operator. Meanwhile, the often inexperienced operator attempts to control the telerobotic system without the benefit of force and torque feedback, and in the case of an inexperienced operator, without the skill required to exploit the telerobotic system so as to successfully disarm and dispose of the IED. In some cases a frustrated IED team may actually abandon the teleoperator system altogether and attempt to disarm the IED manually, thereby exposing the IED team to significantly greater risks.

In addition to the foregoing, and as noted above, it is important that the operator of the telerobotic system be as experienced and well-trained as possible in order to achieve optimal results. It will also be appreciated that experienced and well-trained operators tend to be a precious resource, and hence it would be desirable to use such operators as efficiently as possible. However, as noted above, an IED team generally spends the majority of its time in locating the IED and not in actually approaching, disabling and disposing of the IED. Thus the majority of the operator's time is not currently being used for the tasks which require the greatest skill set, i.e., disabling and disposing of the IED. This means that there is some inefficiency in the way that experienced and well-trained operators are currently being utilized.

Thus there is a need for a new and improved teleoperator system which addresses some or all of the foregoing problems commonly associated with existing teleoperator systems.

### SUMMARY OF THE INVENTION

The present invention provides a new and improved teleoperator system which addresses some or all of the foregoing problems commonly associated with existing teleoperator systems.

More particularly, the present invention provides a new and improved teleoperator system which comprises a master controller and a plurality of slave devices (e.g, remote robotic arms), wherein the master controller can selectively control each of the plurality of slave devices, but the master controller can only control one slave device at any given time. In other words, with the teleoperator system of the present invention, all of the slave devices can be controlled by the master controller, but the master controller only controls one slave device at a time.

In one preferred form of the invention, there is provided a telerobotic system comprising a master controller and a plurality of slave devices, wherein the master controller can operatively control each of the plurality of slave devices, and further wherein the master controller can only control one slave device at any given time.

In another preferred form of the invention, there is provided a telerobotic system comprising a plurality of master controllers and a plurality of slave devices, wherein each master controller can operatively control each of the plurality of slave devices, and further wherein each master controller can only control one slave device at any given time.

In another preferred form of the invention, there is provided a method for performing a task, the method comprising:

providing a telerobotic system comprising a master controller and a plurality of slave devices, wherein the master controller can operatively control each of the plurality of slave devices, and further wherein the master controller can only control one slave device at any given time;

selecting one slave device to be operatively controlled by the master controller; and

using the master controller to operatively control the selected slave device to perform a task.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawing wherein like numbers refer to like parts, and further wherein:

FIG. 1 is a schematic view of a new and improved teleoperator system formed in accordance with the present invention.

### DETAILED DESCRIPTION OF THE PREFERRED EMBODIMENTS

The present invention provides a new and improved teleoperator system which addresses some or all of the foregoing problems commonly associated with existing teleoperator systems.

More particularly, the present invention provides a new and improved teleoperator system which comprises a master controller and a plurality of slave devices (e.g., remote robotic arms), wherein the master controller can operatively control each of the plurality of slave devices, but the master controller can only control one slave device at any given time. In other words, with the teleoperator system of the present invention, all of the slave devices can be controlled by the master controller, but the master controller only controls one slave device at a time.

Thus, one significant aspect of the present invention is to break the normal one-master-one-slave pairing model of the prior art. Instead a plurality of slave devices are assigned to a single master controller, with that master controller being switched between different slave devices so that a single master controller is used to operatively control a plurality of slave devices, albeit one slave device at a time. In this way a single operator using a single master controller can effectively control a plurality of slave devices.

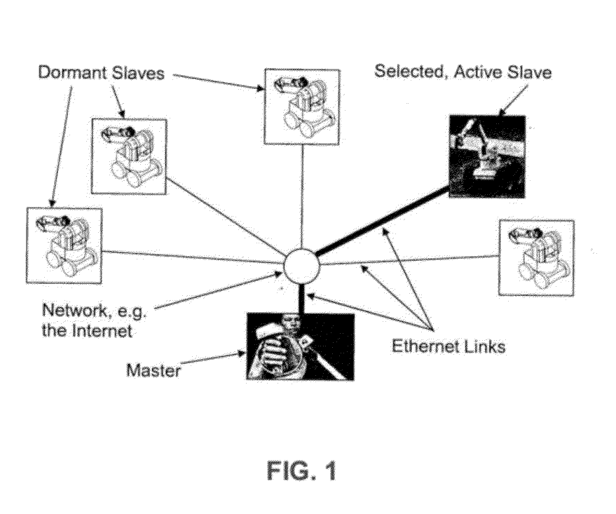

Thus, in one preferred embodiment of the present invention, a large number of generally identical remote slave devices are deployed in the field (for example, a large battlefield) and assigned to one master controller (FIG. 1) operated by an experienced and well-trained operator. The master controller and operator are preferably located at a centralized base. Other operators, using other master controllers linked to other remote slave devices, may be located at the same centralized base. In this case, both masters and slaves are loosely defined to include any parallel-and-serial kinematic structure.

In one preferred form of the present invention, each slave device is preferably a node on an Ethernet-based communications network, as is each master controller, and each slave device and master controller is assigned a unique IP address on either a private network or the Internet. Each master controller operatively controls only one slave device at a time, and slave control can be switched quickly and easily as requests come in from the field. The switching can be done on a simple touchscreen at the master location that tracks requests as they arrive.

For example, once an IED team identifies a possible IED, their UGV slave is deployed and pointed in the direction of the possible IED. Then a “call” is made, either by phone or electronically, for a remotely located, highly-trained operator to take over control of the slave device using their master controller. Then the operator, safely located at a centralized base, “flies” the slave device through the master controller to successful completion of the task. As this occurs, that same operator can also be switching between other remote slave devices also assigned to their master controller, taking advantage of the fact that the remote slave devices generally do not all need to be operatively controlled at the same time.

The ratio of slaves to masters preferably roughly scales with the average duty cycle of slaves. For example, if slaves are active 1% of the time on average, then the ratio of slaves to masters might be roughly 100:1, with the goal of keeping masters busy most of the time, controlling one slave at a time. Like people who can exchange avatars easily in computer-based social networks, the operator goes from one slave to the next using their master controller. The last-operated slave becomes idle (dormant), placing itself in a predefined parked configuration, and the next-operated slave becomes active, instantly bearing the skill and experience of its operator. This scenario increases the amount of time that the operator spends on high expertise tasks, and decreases the amount of time that the operator spends waiting for such high expertise tasks, thereby speeding up the rate at which the operator attains proficiency in a particular task (e.g., disarming and dismantling IEDs) and helping the operator maintain that proficiency.

This framework can also be applied to other areas of security such as frisking; rapid vehicle sniffing, inside and out; or any of a number of like tasks via the avatar telerobotic network. Again, as each avatar slave robot awakens, it instantly adopts the high level of skill and experience of its operator, an expert in that task. Indeed, each operator is even aware of, and routinely adapts to, the most recent insurgent tactics, which continuously evolve.

Significantly, since the cost of each master controller is spread across a large number of slave devices, the master controller can be elaborate, with many degrees of freedom that attach to the hands and arms of the operator. It is envisioned that this approach ultimately will help make walking/running/climbing/kicking possible by feeding back forces and torques through master linkages attached to the legs of the operator too. And, since each master is centrally located, its portability is less important, allowing for a large array of LCD video monitors, for example, to immerse the operator's field of view.

The preferred embodiment is a telerobotic system consisting of a master controller and a plurality of slave devices. In one preferred embodiment, the master controller is the turn-key 7-axis master with special hand controller sold by Barrett Technology, Inc. of Cambridge, Mass., that allows full body mobility and the bilateral transmission of forces and torques about the end tip of the slave device and the full body of the slave device. In one preferred form of the invention, each slave device consists of a standard 7-axis WAM Arm and a BarrettHand BH8-280. This slave configuration is also available as a turn-key system from Barrett Technology, Inc.

In the preferred embodiment, both the master controller and the slave devices literally become nodes on an Ethernet (wired or wireless, or both) network, able to communicate via an ad-hoc private network or on the Internet. Also, in the preferred embodiments, the master controller and, more importantly, the slave devices have no external controller cabinet (e.g., as shown and described in U.S. Pat. No. 7,551,443), which is often as big as the slave device itself. As a result, the slaves become highly portable. Also, it is preferred that the full body of each slave device becomes controllable.

Another aspect of the innovation prefers that the information being transmitted between master and slave can be done at a minimum of 100 Hz (see U.S. Pat. No. 7,168,748). Without this fast connection speed, the slave and master can become noticeably out of synchronization, which can cause the operator to become disoriented.

With these capabilities in place, the electrical network between master and slaves is preferably made over any network using Ethernet cables (and/or wireless Ethernet) and commonly used Internet protocols (e.g., TCP/IP, UDP/IP). In the most basic embodiment of the invention, one master controls many slaves, as shown in FIG. 1, although the master only controls one slave at a time. The master can be seen pictured at the bottom of FIG. 1. The slaves that are not actively being controlled by the master at any given time are temporarily dormant. Via a master controller, the operator can access and control any slave device that is connected to the same Ethernet network and powered on. Power for both master and slaves is preferably sourced locally, requiring no more that 100 Watts of DC power, at a voltage preferably at 48 vdc nominal, but allowed to dip down to 24 vdc during deep discharge of a battery and to rise as high as 90 vdc during battery charging.

In one preferred form of the invention, this invention chooses the unusual step of relying on standard Ethernet technology to support a bilateral telerobotic communications link, so what follows is a discussion of the communications challenges presented by using standard Ethernet technology to support a bilateral telerobotic communications link and the solutions provided for these challenges.

The information communicated between master and slave, routed through the ad-hoc Ethernet link or the Internet, must be updated as frequently as possible. Through testing, it has been determined that 10 msec is the longest desirable update delay, with the fidelity of the bilateral force-torque representation increasing as the maximum delay is reduced to 1 msec.

Note that two factors must be met to support this low delay time: high communications bandwidth and low latency. In wired Ethernet, the low latency can only be guaranteed by a highly-specialized, real-time variant of Ethernet, such as EtherCat. Such systems are non-standard, and cannot be deployed over standard Ethernet links or leverage existing network infrastructures, such as the Internet. Therefore, to avoid such complications, this invention is based on standard Ethernet.

The flow rate of data in the preferred embodiment, which is the communications bandwidth, contains 14 bits of torque data and 22 bits of position data. Controlling dual arm-hand systems with 15 axes of controlled motion at the slave end, and another 15 axes of controlled motion on the master end, therefore requires roughly 30 Kbytes/sec, which is 2 orders of magnitude less than a modern consumer home network.

In this respect it is noted that the aforementioned 30 Kbytes/sec requirement was derived as follows: (14 bits torque+18 bits position)*30 axes*100 Hz=10 Kbytes/s. But IP minimum packet size is 64 bytes+a required 12 byte interframe spacing+an 8 byte preamble sync=84 bytes min effective frame size. This allows for 14 bytes of payload (UDP). In one form of the invention, only the present joint angles may be exchanged between the master and slave, and the torques may be generated locally by PID control. In another form of the invention, positions and torques may both be exchanged. For this case, the requirement is (14 bits torque+22 bits position)*15 axes=68 bytes of data payload+70 bytes framing overhead=138 bytes/frame*2 systems*0.100 Hz=27.6 Kbytes/sec=220.8 Kbits/sec.

Furthermore, it is noted that the aforementioned capacity of a modern consumer home network was derived as follows: 802.11g=24 Mbits/sec, 802.11n=80 Mbits/sec. 80E6/220E3=363=2 orders of magnitude. The numbers are nearly identical for a wired 100BaseT. The numbers are only marginally better for wired Gigabit Ethernet, due to the increased minimum frame size.

However, with Ethernet communications, it is the latency, not communications bandwidth, that limits the highest practical frequency at which closed-loop forces and torques can be represented. High controls bandwidth is critical, as many force interactions (such as colliding with a hard object) contain significant high-frequency components. While there are no latency guarantees in standard Ethernet, as a practical matter, one can isolate a wired Ethernet network to reduce the probability of events that may impair latency. The system will still need to adapt to changing network conditions where latency momentarily exceeds the maximum desired delay time in order to maintain stability while providing the highest force fidelity supported by the communications link at that instant. It is possible to circumvent this limit (increasing the fidelity of the force feedback without decreasing communications latency) to some degree by employing two strategies:

(1) Representation of arbitrary forces with bandwidths up to half the communication rate is possible by exploiting the asymmetry in the master-slave relationship. The slave may transmit force information with as high a bandwidth as possible, while the master removes high-frequency components before transmitting. The master uses this filter to regulate the loop dynamics in order to ensure stability. In this way, the fidelity of the force feedback is asymmetrically increased at the master (where they are necessary for the operator to correctly interpret the interactions of the slave with its environment) and decreased at the slave (where it is an acceptable sacrifice, inasmuch as high-frequency forces produce only minuscule displacements in the position of the slave device due to the mechanical filtering inherent in the structure of the robot).

(2) Representation of specific force events with bandwidths of up to half the servo-rate of the master device is possible by pre-arranging a force-profile representation for specific events of interest, such as colliding with a hard object. The slave device detects such an event and signals the master controller that the event has occurred; in response, the master controller then plays back the pre-arranged force-profile. This additional mode of communication occurs with much higher latency as the slave must wait until it is sure that an event is occurring before signaling the master. However, this latency is not a problem as the introduced high-frequency components are filtered out before being transmitted back to the slave. The master-operator does not notice the additional latency inasmuch as it is still small compared to the timescale of human perception.

If there is a one-to-one joint correspondence between the master and the slaves on the network, as is the case in the preferred embodiment, then the kinematics can be linked in joint space. This system type is the most straightforward. In other embodiments, if a master and its slaves have dissimilar kinematic structures, then they can be linked in Cartesian space. Non-backdrivable systems can be linked in joint space if they are outfitted with joint force and torque sensors, or in Cartesian space if they have an end-effector force-torque sensor.

Thus it will be seen that the present invention provides a new and improved teleoperator system which addresses some or all of the problems commonly associated with existing teleoperator systems. Among other things, the present invention allows an experienced, highly-trained single operator to use a single master controller to operatively control multiple remote slave robots, with the operator controlling one remote slave robot at a time. As a result of this design, the master controller can be elaborate and high performance, since its expense is distributed over numerous remote slave devices. Furthermore, this design encourages centralization of the operator function, enabling continual training for the centralized operator rather than depending on local operators who wait long periods between activities and therefore do not maintain the high level of training required to exploit rich, elaborate, high performance feed back. In addition to the foregoing, since the centralized operator does not have long periods between activities, there is increased efficiency in the utilization of operator time.

### MODIFICATIONS

It is to be understood that the present invention is by no means limited to the particular constructions herein disclosed and/or shown in the drawings, but also comprises any modifications or equivalents within the scope of the invention.

What is claimed is:

1. A telerobotic system comprising a master controller and a plurality of slave devices, wherein the master controller can operatively control each of the plurality of slave devices, and further wherein the master controller can only control one slave device at any given time.

2. A telerobotic system according to claim 1 wherein the system includes full force and torque feedback in either joint or Cartesian space.

3. A telerobotic system according to claim 1 wherein the master controller controls degrees of freedom via the hands and arms of the human operator.

4. A telerobotic system according to claim 1 wherein the master controller controls degrees of freedom via the full body of the human operator.

5. A telerobotic system according to claim 1 wherein the human operator is immersed in video feedback via large monitors or screens, a heads-up display, or virtual-reality eyeglasses.

6. A telerobotic system according to claim 1 that employs any combination of force and torque feedback, up to full body master control, and immersive virtual reality video feedback.

7. A telerobotic system according to claim 1 wherein the master controller and each of the plurality of slave devices is a node on a communications network.

8. A telerobotic system according to claim 7 wherein the communications network comprises nodes in addition to the master controller in each of the plurality of slave devices.

9. A telerobotic system according to claim 7 wherein the communications network is an Ethernet-based network.

10. A telerobotic system according to claim 7 wherein the master controller and each of the plurality of slave devices is assigned a unique IP address.

11. A telerobotic system comprising a plurality of master controllers and a plurality of slave devices, wherein each master controller can operatively control each of the plurality of slave devices, and further wherein each master controller can only control one slave device at any given time.

12. A telerobotic system according to claim 11 wherein the number of slave devices significantly exceeds the number of master controllers.

13. A telerobotic system according to claim 11 wherein each master controller is operated by a single operator.

14. A method for performing a task, the method comprising:
providing a telerobotic system comprising a master controller and a plurality of slave devices, wherein the master controller can operatively control each of the plurality of slave devices, and further wherein the master controller can only control one slave device at any given time;
selecting one slave device to be operatively controlled by the master controller; and
using the master controller to operatively control the selected slave device to perform a task.

15. A method according to claim 14 further comprising selecting a different slave device to be operatively controlled by the master controller; and
using the master controller to operatively control that different slave device to perform a task.
